(19) United States
(12) Patent Application Publication
(10) Pub. No.: US 2005/0191599 A1
(43) Pub. Date: Sep. 1, 2005

(54) Denture adhesive removal method

(76) Inventors: Randy Slack, Underwood, IA (US); Angie Slack, Underwood, IA (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 10/902,716

(22) Filed: Jul. 29, 2004

Related U.S. Application Data
(60) Provisional application No. 60/548,612, filed on Feb. 27, 2004.

(51) Int. Cl. A61C 13/00

(52) U.S. Cl. 433/167; 433/229

(57) ABSTRACT

A method of cleaning denture adhesive material from dentures and gums comprising the steps of providing a generally planar flexible sheet of spunbound polypropylene and engaging at least one of a denture wearer's gums, dentures and teeth having at least some denture adhesive material thereon with the generally planar flexible sheet of spunbound polypropylene. The generally planar flexible sheet of spunbound polypropylene is then rubbed over and on locations on at least one of a denture wearer's gums, dentures and teeth having at least some denture adhesive material thereon and this rubbing action acts to remove substantially all of the at least some denture adhesive material from the at least one of a denture wearer's gums, dentures and teeth via contact with the generally planar flexible sheet of spunbound polypropylene.

### CROSS-REFERENCE TO RELATED PROVISIONAL PATENT

This application claims priority based on a provisional patent, specifically on the Provisional Patent Application Ser. No. 60/548,612 filed Feb. 27, 2004.

### BACKGROUND OF THE INVENTION

1. Technical Field

The present invention is directed to denture cleaning methods and, more particularly, to a denture adhesive removal method which involves the use of spunbound polypropylene in sheet form which removes denture adhesive from the gums and dentures of the denture wearer by rubbing the spunbound polypropylene sheet over the areas having adhesive thereon.

2. Description of the Prior Art

There has been a steady and significant increase in the number of persons who, for one reason or another, have had to have some or all of their teeth replaced with artificial teeth, commonly known as dentures. Numerous reasons have been offered for this increase in the amount of dental work which is being performed, but the plain truth is that the reasons for the increase are not as important as the simple fact that an ever-increasing number of persons need to wear bridges, caps, and dentures. Many of these bridges and dentures are made to be removable when the individual does not wish to wear the dentures or bridges, and these removable types of artificial teeth are generally held within the mouth by an adhesive substance such as those commonly sold under such brand names as POLYGRIP®, FIXODENT®, and EFFERGRIP®.

Regardless of the adhesive material used, however, each and every denture wearer encounters the same problem when the dentures are to be removed from his or her mouth, and that is the subsequent removal of the denture adhesive from their gum surfaces and from the dentures themselves. All different types of methods and materials have been tried in the past, including the use of sponges, washcloths, and other such cleaning devices, but each of these materials has inherent disadvantages and commonly do not remove all of the adhesive material from the gums and/or dentures of the denture wearer without excessive rubbing of the gum surfaces. There is therefore a need for a method of cleaning dentures with a material with has no relationship with previously used denture cleaning materials, but which has been found to be superior to those commonly available denture cleaning materials.

Therefore, an object of the present invention is to provide an improved denture adhesive removal method.

Another object of the present invention is to provide an improved denture adhesive removal method which involves the use of spunbound polypropylene in sheet form which removes denture adhesive from the gums and dentures of the denture wearer by rubbing the spunbound polypropylene sheet over the areas having adhesive thereon.

Another object of the present invention is to provide an improved denture adhesive removal method which does not require solvents or harsh abrasives yet will quickly and easily remove the denture adhesive material from the dentures and gums of the denture wearer.

Another object of the present invention is to provide an improved denture adhesive removal method which may be used in almost any situation regardless of the proximity of washroom facilities.

Finally, an object of the present invention is to provide an improved denture adhesive removal method which is relatively simple to manufacture and is easy and safe to use.

### SUMMARY OF THE INVENTION

The present invention provides a method of cleaning denture adhesive material from dentures and gums comprising the steps of providing a generally planar flexible sheet of spunbound polypropylene and engaging at least one of a denture wearer's gums, dentures and teeth having at least some denture adhesive material thereon with the generally planar flexible sheet of spunbound polypropylene. The generally planar flexible sheet of spunbound polypropylene is then rubbed over and on locations on at least one of a denture wearer's gums, dentures and teeth having at least some denture adhesive material thereon and this rubbing action acts to remove substantially all of the at least some denture adhesive material from the at least one of a denture wearer's gums, dentures and teeth via contact with the generally planar flexible sheet of spunbound polypropylene.

The denture adhesive removal method of the present invention is not shown in the prior art. For example, although spunbound polypropylene has been used for the manufacture of hairnets and the like for many years, the use of spunbound polypropylene in and around the mouth and gums of an individual is heretofore unknown and the adhesive removal properties of spunbound polypropylene likewise heretofore have not been known. Furthermore, because the spunbound polypropylene may be formed as small sheets of material, they may be easily packaged for transport to various locations, thus permitting the denture wearer to have access to the adhesive removal method of the present invention in many different situations. Finally, because the spunbound polypropylene sheet of the present invention includes no additional abrasives or catalyst materials operative to initiate the breakdown of the adhesive material, the method of the present invention is safe to use for virtually all denture users regardless of their particular gum sensitivity or potential allergic reaction. It is thus seen that the present invention provides a substantial improvement over those denture adhesive removal devices and methods found in the prior art.

### BRIEF DESCRIPTION OF THE DRAWINGS

FIG. 1 is a perspective view of the spunbound polypropylene of the present invention being used to clean dentures within the wearer's mouth;

FIG. 2 is a detailed perspective view showing the sheet of spunbound polypropylene being used to clean the gums of a denture wearer; and

FIG. 3 is a detailed perspective view of the spunbound polypropylene being used to remove the denture adhesive from the dentures and then being discarded in a wastebasket.

### DESCRIPTION OF THE PREFERRED EMBODIMENT

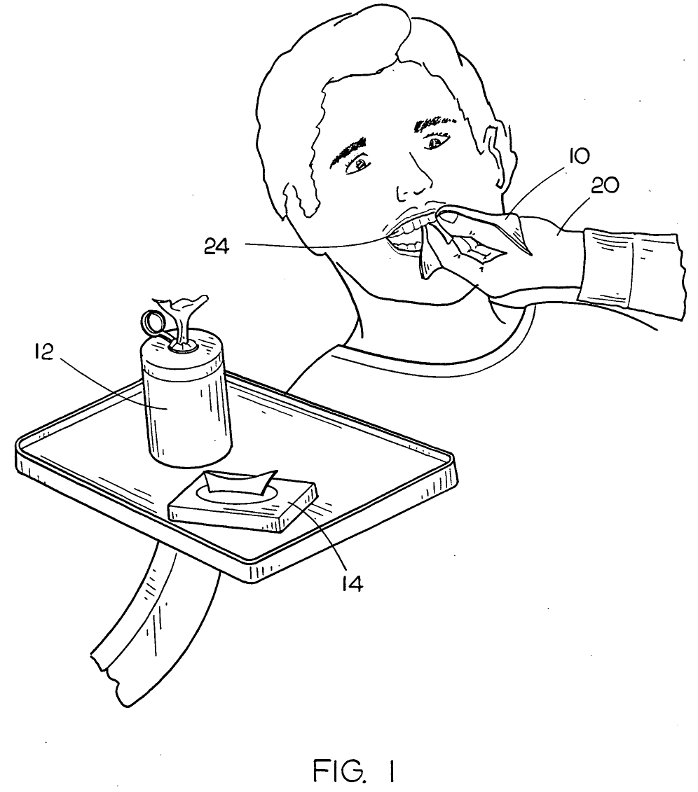

The denture cleaning method of the present invention is shown best in FIGS. 1-3 as including the following steps. First of all, the material which has been found to be most advantageous for removal of denture adhesive from both gum surfaces and from the dentures themselves is a material which is actually used in the formation of hairnet devices, specifically spunbound polypropylene. Spunbound polypropylene is a mesh material which is very thin and is formed in sheets by a spinning and extruding process such as that commonly used in connection with man-made fibrous materials. It is commonly used, as was stated previously, in connection with hairnets, but in connection with the method of the present invention, it is expected that the spunbound polypropylene would be formed into generally rectangular sheets 10 having dimensions of approximately three inches by five inches, the sheets 10 being stored within various types of dispenser packages 12 and 14 such as those shown in FIG. 1. Of course, the exact nature of the storage of the generally rectangular sheets 10 is not critical to the present invention, and likewise the specific dimensions of the sheet 10 are not critical so long as there is sufficient material for an individual to properly use the sheet 10 while performing the method of the present invention.

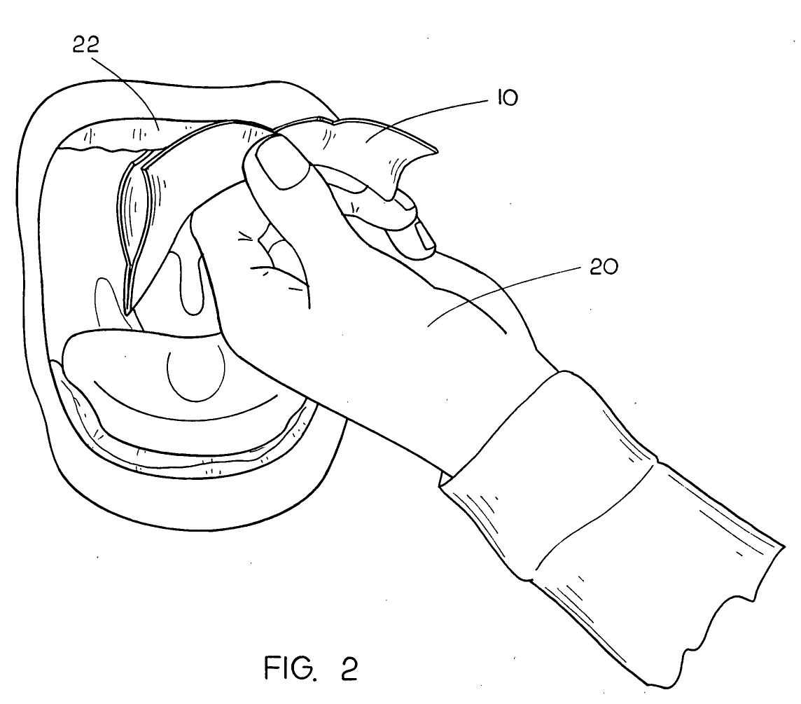

A denture wearer would use the method of the present invention in the following manner. First, a sheet 10 of the spunbound polypropylene would be removed from the selected dispenser package 12 and 14 and the sheet 10 would be grasped by the user's hand 20, as shown in FIG. 2. The sheet 10 would then be rubbed back and forth over the gum surfaces 22 of the denture wearer in a gentle back-and-forth motion which would engage and remove lingering denture adhesive from the gum surfaces 22. It has been found that the mesh-like material of the spunbound polypropylene engages adhesive material remaining on the gum surfaces 22 and removes the adhesive material from the gum surfaces 22 without the need for vigorous, potentially damaging, rubbing of the gum surfaces 22 by the sheet 10. It is believed that this superior cleaning and removal characteristic of the sheet 10 of spunbound polypropylene is due both to the material characteristics and the mesh-like physical structure of the sheet 10, although the exact reasons for the vastly improved cleaning characteristics of the present invention will not specifically be reviewed in this disclosure. Also, a property of spunbound polypropylene is that it does not absorb water, which means that the sheet acts as a soft abrasive material that will not absorb the fluids on the dentures or in the user's mouth. This property of spunbound polypropylene makes the present invention far more sanitary than those absorbent materials used in the prior art, as there is little if any transfer of fluids from the fingers to the gum surfaces through the sheet 10. This is another advantage over the prior art, and one which is not suggested by the absorbent materials previously used.

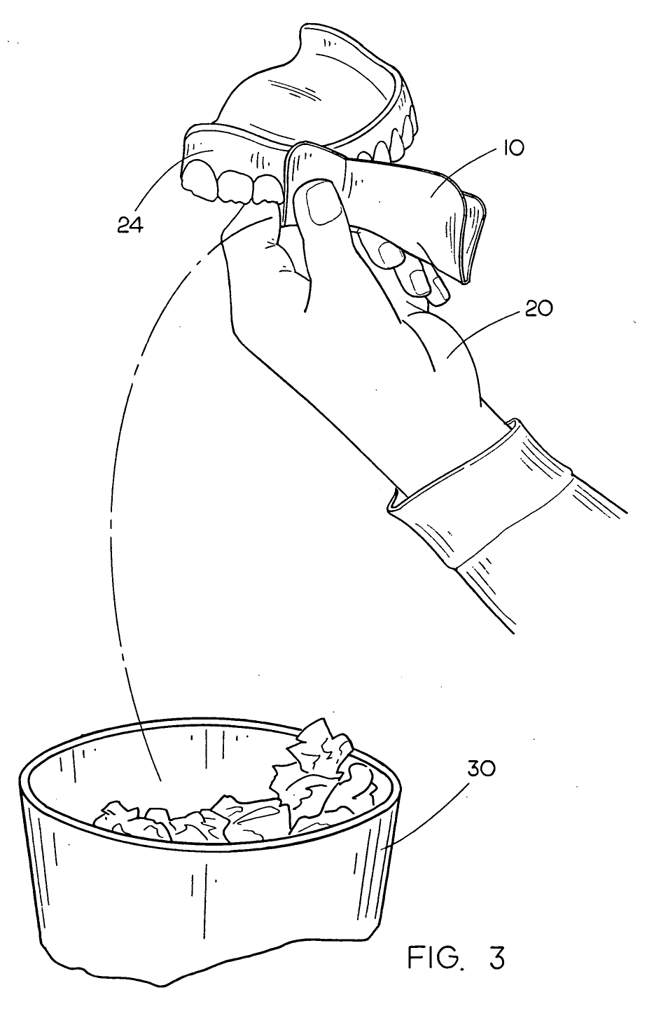

Once the gum surfaces 22 of the individual are cleaned using the sheet 10, the sheet 10 is then used to clean the denture surfaces 24, as shown best in FIG. 3. Once the denture surfaces 24 are completely cleaned of residual adhesive material by use of the sheet 10 of the present invention, the sheet 10 may then be discarded into a wastebasket 30 or the like, as the sheets 10 of the present invention are designed to be disposable after use. Although it may be possible to use the sheets 10 of the present invention multiple times, for the sake of efficiency and, even more importantly, hygiene, it is preferred that the sheets 10 be discarded after a single use in cleaning the gum surfaces 22 and denture surfaces 24 of the denture wearer.

It is to be understood that numerous additions, substitutions, and modifications may be made to the denture cleaning method of the present invention which fall within the intended broad scope of the above description. For example, the size and shape of the sheets 10 of spunbound polypropylene may be modified or changed, depending on the cleaning characteristics desired in use of the present invention. Furthermore, it may be beneficial or desirable to impregnate the spunbound polypropylene with a flavoring material such as mint or citrus or other such flavor to enhance the cleaning characteristics of the method of the present invention, specifically by removing or masking odors emanating from the gum surfaces 22 and denture surfaces 24. Also, it should be noted that the method of the present invention can be used not only to clean dentures and gums after removal of the dentures from the wearer's mouth, but also immediately after insertion of the denture into the person's mouth, when adhesive material is squeezed out from underneath the dentures onto the gum surfaces. In this situation, the sheet 10 of the present invention may be used to quickly and easily remove the excess adhesive material. The denture wearer thus is able to more confidently insert the dentures knowing that the denture adhesive removal method of the present invention is available for use to remove excess adhesive material. Finally, it should be noted that numerous different types of dispenser packages may be used with the sheets 10 of the present invention so long as individual sheets are quickly and easily obtained by the denture wearer for use in the present method.

There has therefore been shown and described a denture adhesive removal method which accomplishes at least all of its intended purposes.

1. A method of cleaning denture adhesive material from dentures and gums comprising the steps of:
providing a generally planar flexible sheet of spunbound polypropylene;
engaging at least one of a denture wearer's gums, dentures and teeth having at least some denture adhesive material thereon with said generally planar flexible sheet of spunbound polypropylene;
rubbing said generally planar flexible sheet of spunbound polypropylene over and on locations on at least one of a denture wearer's gums, dentures and teeth having at least some denture adhesive material thereon; and
removing substantially all of said at least some denture adhesive material from said at least one of a denture wearer's gums, dentures and teeth via contact with said generally planar flexible sheet of spunbound polypropylene.

2. The method of claim 1 wherein said step of providing a generally planar flexible sheet of spunbound polypropylene further comprises releasably retaining a plurality of said generally planar flexible sheets of spunbound polypropylene within a dispensing container from which a selected one of said generally planar flexible sheets of spunbound polypropylene is removable.

3. The method of claim 2 wherein said generally planar flexible sheet of spunbound polypropylene is generally rectangular.

4. A method of cleaning denture adhesive material from dentures and gums comprising the steps of:
providing a plurality of generally planar flexible sheets of spunbound polypropylene;
releasably retaining said plurality of said generally planar flexible sheets of spunbound polypropylene within a dispensing container from which a selected one of said generally planar flexible sheets of spunbound polypropylene is removable;
engaging at least one of a denture wearer's gums, dentures and teeth having at least some denture adhesive material thereon with said selected one of said generally planar flexible sheets of spunbound polypropylene;
rubbing said selected one of said generally planar flexible sheets of spunbound polypropylene over and on locations on at least one of a denture wearer's gums, dentures and teeth having at least some denture adhesive material thereon;
removing said at least some denture adhesive material from said at least one of a denture wearer's gums, dentures and teeth via contact with said selected one of said generally planar flexible sheets of spunbound polypropylene;
repeating said engaging, rubbing and removing steps until substantially all of said denture adhesive material is removed from said at least one of a denture wearer's gums, dentures and teeth; and
discarding said selected one of said generally planar flexible sheets of spunbound polypropylene following removal of substantially all of said denture adhesive material from said at least one of a denture wearer's gums, dentures and teeth.
